(19) United States
(12) Patent Application Publication
(10) Pub. No.: US 2024/0009957 A1
(43) Pub. Date: Jan. 11, 2024

(54) Biodegradable Nonwoven With Self-Adhesive For Packaging

(71) Applicant: Nonwoven Network LLC, Naples, FL (US)

(72) Inventor: Stephen W. Foss, Naples, FL (US)

(73) Assignee: Nonwoven Network LLC, Naples, FL (US)

(21) Appl. No.: 18/218,191

(22) Filed: Jul. 5, 2023

Related U.S. Application Data
(60) Provisional application No. 63/358,569, filed on Jul. 6, 2022.

(51) Int. Cl. B32B 5/02; D04H 1/435; B32B 37/04; B32B 38/00; D04H 1/55; B32B 5/26; B32B 27/36; B32B 27/12

(52) U.S. Cl. CPC B32B 5/022; D04H 1/435; B32B 37/04; B32B 38/145; D04H 1/55; B32B 5/266; B32B 27/36; B32B 27/12; D10B 2401/12; D10B 2401/20; D10B 2505/10; B32B 2439/70; B32B 2262/0276; B32B 2307/7163; B32B 2307/7242; B32B 2307/4023; B32B 2309/02; B32B 2307/72; B32B 2367/00; B32B 2305/28

(57) ABSTRACT

The present disclosure includes a composition and method of making a nonwoven that creates a self-adhesive during lamination that is suitable for use as an impermeable or almost impermeable packaging medium and is 100% biodegradable. Unlike other films that have difficulty in bonding to a substrate that may cause air bubbles and fisheyes, the present method of making a film, and related film composition needs no adhesive to bond to a substrate. In one aspect, PLA mono-component fibers are utilized at a specific blend to achieve impermeability and transparency and/or semi-transparency properties. The manufacture of the same is also disclosed.

### CROSS-REFERENCE TO RELATED APPLICATIONS

The present application claims the benefit of the filing date of U.S. Provisional Application No. 63/358,569 filed Jul. 6, 2022, the disclosure of which is hereby incorporated herein by reference.

### FIELD OF USE

The present disclosure relates to a biodegradable nonwoven, and more particularly to the manufacture of a 100% biodegradable nonwoven that has self-adhesive properties to allow lamination of another substrate onto the nonwoven to create an impermeable membrane without other additives in an adhesive or any fisheyes or air bubbles.

### BACKGROUND OF THE INVENTION

With the proliferation of biodegradable and recycled materials, there is a need for a substrate, which provides for 100% bio-degradable and does not contain any inert or non-biodegradable components. Packaging of food products from tea and coffee to candies, cookies, crackers, to snacks require a packaging material that is from almost to fully impermeable to keep the flavor inside the package.

Generally the packages are in the form of pouches, either flat or stand up with a gusseted bottom. These packages are generally made with a film that is heat or ultrasonic sealable. These packages are preferable to boxes made from cardboard because they are lighter and take up less space.

Films of various types have been used in packaging of materials from food products to small loose pieces. Typically the films are made from polyethylene, polypropylene, polyester, Mylar® (a form of polyester resin made by DuPont used to make heat-resistant plastic films and sheets), metallized Mylar®, acetate, and other polymers.

The lamination of two films or a film and other substrate such as paper requires liquid adhesives between the layers to get a bond. Most adhesives that have superior performance and biodegradable are usually solvent based and not beneficial to the environment. Consumers have become very concerned that packaging materials are not biodegradable in less than 6 months. None of the polymers listed above are biodegradable in less than 6 months.

Much work has been accomplished by film manufacturers to make a film from polylactic acid (PLA), which is both biodegradable and compostable in less than 90 days. However because of the low Tg, PLA films cannot be laminated without an adhesive.

There have been attempts to solve this issue that has been met with limited success. U.S. Pat. No. 8,828,895 describes a method of making filter fabrics by utilizing mono-component, mono-constituent fibers made from both high and low melt temperature Polylactic Acid (PLA) fibers. Many nonwovens have been proven to be biodegradable such as the One Earth® product line of tea bags by Nonwoven Network under U.S. Pat. No. 8,828,895. However, most nonwovens are opaque and it is not possible to see the contents inside a package.

In addition, for those applications that do require adhesive bonding such current technology adhesives have many drawbacks. Adhesives have been a central aspect of numerous manufacturing and assembly processes, spanning food industry, healthcare, photovoltaics, automotive, and aerospace sectors. Despite their vast implementation, many polymeric substrates of commercial relevance remain notoriously difficult to adhere, especially with the most widely produced polyolefins like polyethylene and polypropylene. Commonly, when attempting to adhere such polymer substrates, poor adhesion and hence mechanical properties are obtained, mandating the use of expensive pretreatment (e.g., corona, flame, plasma, acid treatments) or post-adhesion reinforcement by mechanical fastening. Compounding the prior problem, even when adhesion is possible, the process of adhesion can be inefficient and complex involving specialized equipment and/or conditions consisting of high temperatures, long cure times, and vacuum.

Therefore, there is a need for a nonwoven to be used in packaging materials to have the ability form its own adhesive to eliminate the need for additional adhesives. There is also a need for a packaging material that can be transparent or partially transparent or translucent to see the materials inside. In addition, there is a need in the industry for a combination of nonwoven and film without using additional adhesives that can create a high level of impermeability for polymeric substrates that can set under ambient conditions and use simple processes for enabling cost savings, faster production, and greater design freedom to producers.

### SUMMARY

Compared to the above compositions and methods the present disclosure fulfills the above criteria and provides additional benefits that state of the art systems cannot provide.

The current composition and method provides for a mono-component, polylactic acid (PLA) fiber that forms an adhesive on its surface when subjected to heat in a range about 105-140° C. The low melt PLA fiber is completely amorphous while the high melt fiber is crystalline, and the nonwoven may contain a high melt (145-175° C.) and a low melt (105-165° C.) PLA fibers.

PLA can be produced in both a L and/or D configuration. The L form has a higher melt point. By combining the D & L forms during polymerization, the melting point can be lowered and controlled at a specified melt temperature. Polymerization of a racemic mixture of L- and D-lactides usually leads to the synthesis of poly-DL-lactide (PDLLA), which is amorphous. Use of stereospecific catalysts can lead to heterotactic PLA which has been found to show crystallinity. The degree of crystallinity, and hence many important properties, is largely controlled by the ratio of D to L enantiomers used, and to a lesser extent on the type of catalyst used. Apart from lactic acid and lactide, lactic acid O-carboxyanhydride (“lac-OCA”), a five-membered cyclic compound has been used academically as well. This compound is more reactive than lactide, because its polymerization is driven by the loss of one equivalent of carbon dioxide per equivalent of lactic acid.

Due to the chiral nature of lactic acid, several distinct forms of polylactide exist: poly-L-lactide (PLLA) is the product resulting from polymerization of L,L-lactide (also known as L-lactide).

It is well known that PLA polymers range from amorphous glassy polymer to semi-crystalline and highly crystalline polymer with a known glass transition 60-65° C., a melting temperature 130-180° C., and a tensile modulus 2.7-16 GPa. Heat-resistant PLA can withstand temperatures of 110° C. The basic known mechanical properties of PLA are between those of polystyrene and PET. It is also known that the melting temperature of PLLA can be increased by 40-50° C. and its heat deflection temperature can be increased from approximately 60° C. to up to 190° C. by physically blending the polymer with PDLA (poly-D-lactide). PDLA and PLLA form a highly regular stereo-complex with increased crystallinity. The temperature stability is maximized when a 1:1 blend is used, but even at lower concentrations of 3-10% of PDLA, there is still a substantial improvement. In the latter case, PDLA acts as a nucleating agent, thereby increasing the crystallization rate. Biodegradation of PDLA is slower than for PLA due to the higher crystallinity of PDLA. The flexural modulus of PLA is higher than polystyrene and PLA has good heat seal.

In one aspect, a non-woven fiber composition web of mono-component, mono-constituent PLA fiber composition consisting of: a mono-component, mono-constituent polylactic acid (PLA) fiber. The polylactic acid (PLA) fiber has different deniers and blend percentages of high and low melt fibers. The fibers, in one embodiment, have a melt flow temperature in a range of 145-175° C. and 105-165° C., for high melt flow fibers and low melt flow fibers, respectively.

In another aspect, certain embodiments according to the invention provide a process for preparing a polylactic acid (PLA) nonwoven fabric with the nonwoven fibers. In accordance with certain embodiments, the process includes providing a stream of molten or semi-molten PLA resin, forming a plurality of drawn PLA continuous filaments, depositing the plurality of PEA continuous filaments onto a collection surface, exposing the plurality of PLA continuous filaments to an extrusion blown film process for making film, and bonding a substrate, such as but not limited to a polymer, onto the PLA film to for a PLA laminated and impermeable membrane without the use of an adhesive.

Blown film extrusion is a processing technique used for producing a biaxial melt drawn film. This technique uses air pressure to produce a transverse direction (TD) draw and a higher speed haul off roll speed to provide a machine direction (MD) draw.

This technique is used to process several types of polymer films including polyethylene, polypropylene (PP), polyvinyl chloride (PVC), polystyrene (PS), ethylene vinyl acetate (EVA), ethylene vinyl alcohol (EVOH), polyamide (PA), and polyurethane (PU), and the like. An alternative process is a cast film process that quenches molten extrudate on a chilled steel roller or rollers after it exits the die. Sheet can also be made with this process; however, the line speeds are slower and there are multiple chill rolls to provide the required heat removal. A further alternative process is extrusion coating and extrusion lamination. The difference between extrusion coating and extrusion lamination is the presence of the second or auxiliary web that sandwiches the melt on the second side. For extrusion coating, only one substrate is used and the extrudate coats the surface and is quenched on a chill roll much like a cast film process. The various products that are typically made with extrusion coating and laminations include lidding stock, candy wrapper, snack food bags, and medical packaging.

In another aspect, a non-woven fabric composition web for packaging food stuff, comprises: a plurality of biodegradable, mono-component, mono-constituent 100% amorphous low melt polylactic acid (PLA) fibers having a melt flow temperature in a range of 105-165° C.; a plurality of biodegradable, mono-component, mono-constituent semi-crystalline and/or crystalline high melt polylactic acid (PLA) fibers having a melt flow temperature in a range of 145-175° C.; the low and the high melt polylactic acid(PLA) fibers both having different deniers and a blend percentages forming a PLA nonwoven fabric; a substrate selected from a group consisting of another nonwoven, a layer of paper, a layer of polymer film, a PLA film, a mixed polymer and metallic layer or a ceramic layer, an aluminum foil layer, a metallic layer, and any combination thereof; wherein, the amorphous mono-component PLA fiber forms an adhesive on a surface of the PLA fabric when subjected to heat in a range of about 105-140° C. and the substrate is laminated unto the PLA film or other substrate without the use of an external adhesive to form an impermeable membrane void of air bubbles or fisheyes in the impermeable membrane.

In yet another aspect, a process of making a non-woven fabric composition web for packaging food stuff, comprises: preparing a polylactic acid (PLA) nonwoven fabric with the nonwoven fibers; wherein the fabric includes: a plurality of biodegradable, mono-component, mono-constituent 100% amorphous low melt polylactic acid (PLA) fibers having a melt flow temperature in a range of 105-165° C.; a plurality of biodegradable, mono-component, mono-constituent semi-crystalline and/or crystalline high melt polylactic acid (PLA) fibers having a melt flow temperature in a range of 145-175° C.

The low and the high melt polylactic acid(PLA) fibers both having different deniers and a blend percentages forming a PLA nonwoven fabric; forming an adhesive with the amorphous mono-component PLA on a surface of the PLA when subjected to heat in a range of about 105-140C; and bonding or laminating a substrate to the PLA film without the use of an external adhesive to form an impermeable membrane void of air bubbles or fisheyes in the impermeable membrane due a combination of surface adhesive from the low melt PLA and the film that results in an impermeable product; wherein the substrate is selected from a group consisting of another nonwoven, a layer of paper, a layer of polymer film, a PLA film, a mixed polymer and metallic layer or a ceramic layer, an aluminum foil layer, a metallic layer, and any combination thereof.

In another aspect, a process includes a process of making a non-woven fabric composition web for packaging food stuff or other products, comprising: preparing a polylactic acid (PLA) nonwoven fabric with the nonwoven fibers; wherein the fabric includes: a plurality of biodegradable, mono-component, mono-constituent up to 90% amorphous low melt polylactic acid (PLA) fibers having a melt flow temperature in a range of 105-165° C.; a plurality of biodegradable, mono-component, mono-constituent semi-crystalline and/or crystalline high melt polylactic acid (PLA) fibers having a melt flow temperature in a range of 145-175° C.; the low and the high melt polylactic acid(PLA) fibers both having different deniers and a blend percentages forming a PLA nonwoven fabric; forming an adhesive with the amorphous mono-component PLA on a surface of the PLA when subjected to heat in a range of about 110-145° C.; and bonding or laminating a substrate to the PLA film without the use of an external adhesive to form an impermeable membrane void of air bubbles or fisheyes in the impermeable membrane due a combination of surface adhesive from the low melt PLA and the film that results in an impermeable product or a non-woven fabric composition web for packaging food stuff or other products; wherein the substrate is selected from a group consisting of another nonwoven, a layer of paper, a layer of polymer film, a PLA film, a mixed polymer and metallic layer or a ceramic layer, an aluminum foil layer, a metallic layer, and any combination thereof.

Further the process may include wherein the degree of impermeability is also controlled by adjusting temperature, pressure, and dwell time during lamination; and wherein temperature is increased up to 150° C., and line speeds of 5 to 100 meters per min are done to allow for a nip contact time as low as less than 1 second.

The process may also further include providing a stream of molten or semi-molten PLA resin, forming a plurality of drawn PLA continuous filaments, depositing the plurality of PLA continuous filaments onto a collection surface, exposing the plurality of PLA continuous filaments to an extrusion blown film process for making film, and bonding the substrate onto the PLA film to form a PLA laminated and impermeable membrane.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed composition and method, reference is made to the accompanying figures, wherein:

FIG. 1 shows an electron microscope view of low malt fibers (130° C.) after activation in accordance with one embodiment of the present disclosure;

FIG. 2 shows a diagram of lamination using a “s” wrapped heated roll and nip;

FIG. 3 illustrates a diagram of lamination using a heated oven and np rolls to complete the lamination without adhesive;

FIG. 4 shows a block diagram illustrating one embodiment of a manufacturing method of the lamination of the nonwoven and film in a block diagram shown in FIG. 1;

FIG. 5 is a photomicrograph of the laminated nonwoven and film showing no air bubble or fisheyes;

FIG. 6 shows the semi-transparency of the nonwoven/film laminate; and

FIGS. 7A-7D illustrate various configurations of the laminate and substrate, FIG. 7A illustrates a cross sectional view of one layer of the laminate and substrate; FIG. 7B illustrates a cross sectional view of two layers of the layer in FIG. 7A in a back to face configuration; similarly FIG. 7C illustrates a cross sectional view of two layers in a back to back configuration; and FIG. 7D illustrates a cross sectional view of two layers in a face to face configuration.

### DETAILED DESCRIPTION

The invention includes, according to certain embodiments, systems, and processes for preparing polylactic acid (PLA) nonwoven fabric films with a substrate layer for food stuff packaging. Food stuff includes, but is not limited to, beverage compositions such as tea leaves, coffee beans and granules; cookies and biscuits, milk, juices, as well as meats, fish, vegetables, fruits, and the like. In particular, embodiments of the invention are directed to systems and processes that utilize means for controlling the bonding of the PLA film to the substrate without the use of an adhesive, including elimination of air bubbles or fisheyes when bonding the PLA to the substrate. In this regard, PLA processing can occur at high speeds with minimal waste, thereby making the present PLA film production economically attractive for manufacturing and mass production.

The term “fiber” can refer to a fiber of finite length or a filament of infinite length. As used herein, the term “mono-component” refers to fibers formed from one polymer or formed from a single blend of polymers. Of course, this does not exclude fibers to which additives have been added for color, anti-static properties, lubrication, hydrophilicity, liquid repellency, and the like. As used herein, the terms “nonwoven,” “nonwoven web” and “nonwoven fabric” refer to a structure or a web of material which has been formed without use of weaving or knitting processes to produce a structure of individual fibers or threads which are intermeshed, but not in an identifiable, repeating manner.

Nonwoven webs have been, in the past, formed by a variety of conventional processes for films such as, for example, melt blown or blown film processes, film extrusion processes, and casting processes. As used herein, the term “melt blown” refers to a process in which fibers are formed by extruding a molten thermoplastic material through a plurality of fine, usually circular, die capillaries into a high velocity gas (e.g. air) stream which attenuates the molten thermoplastic material and forms fibers or a film, which can be to microfiber diameter. Thereafter, the melt blown fibers are carried by the gas stream and are deposited on a collecting surface to form a web of random melt blown fibers. Such a process is disclosed, for example, in U.S. Pat. No. 3,849,241 to Buntin et al.

As used herein. “100% PLA” may also include, up to 5% additives including additives and/or masterbatches of additives to provide, by way of example only, color, softness, slip, antistatic protection, lubricity, hydrophilicity, liquid repellency, antioxidant protection and the like. In this regard, the nonwoven may comprise 95-100% PLA, such as from 96-100% PLA, 97-100% PLA, 98-100% PLA, 99-100% PLA, and the like. When such additives are added as a masterbatch, for instance, the masterbatch carrier may primarily comprise PLA in order to facilitate processing and to maximize sustainable content within the formulation.

Generally, polylactic acid based polymers are prepared from dextrose, a source of sugar, derived from field corn. In North America corn is used since it is the most economical source of plant starch for ultimate conversion to sugar. However, it should be recognized that dextrose can be derived from sources other than corn. Sugar is converted to lactic acid or a lactic acid derivative via fermentation through the use of microorganisms. Lactic acid may then be polymerized to form PLA. Examples of such high performance PLA resins include L105, L130, L175, and LX175, all from Coition of Arkelsedijk 46, 4206 A C Gorinchem, the Netherlands. Thus, besides corn other agricultural based sugar source could be used including rice, sugar beets, sugar cane, wheat, cellulosic materials, such as xylose recovered from wood pulping, and the like. In some embodiments, the nonwoven fabrics may be biodegradable. Total Corbion offer a family of PLAs that are made from sugar cane waste that is certified non-GMO which can be very important for certain consumer groups.

“Biodegradable” refers to a material or product which degrades or decomposes under environmental conditions that include the action of microorganisms. Thus, a material is considered as biodegradable if a specified reduction of tensile strength and/or of peak elongation of the material or other critical physical or mechanical property is observed after exposure to a defined biological environment for a defined time. Depending on the defined biological conditions, a fabric comprised of PLA might or might not be considered biodegradable. A special class of biodegradable products made with a bio-based material might be considered as compostable if it can be degraded in a composing environment. The European standard EN 13432, “Proof of Compostability of Plastic Products” may be used to determine if a fabric or film comprised of sustainable content could be classified as compostable.

U.S. Pat. No. 8,828,895 to Foss describes methods to select a percentage of high temperature PLA blended with a low temperature PLA. The present invention is unlike bi-component fibers that have a specific percentage of high temperature polymer in a core and percentage of low temperature polymer on a sheath. The bi-component fiber arrangement limits the ability to provide an intimate blend of fibers that can be adjusted for specific physical properties.

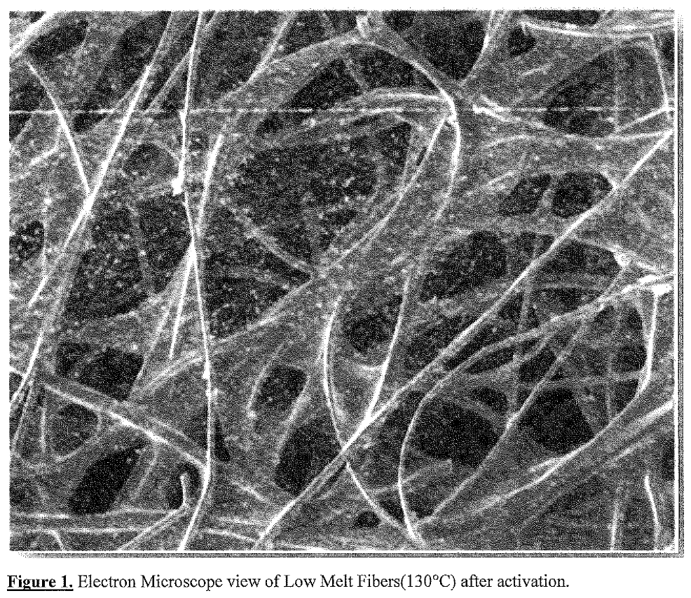

By using mono-component, mono-constituent fibers, the diameter, length, fiber shape, and melt temperature can be adjusted to achieve that desired properties. The low melt fiber melts completely and flows and adheres to the high melt fibers as shown in for example in FIG. 1. As shown, reference number 101 shows a PLA or Co-PLA fiber with a low melting point at about 130C. In this embodiment, the fiber is shown after calendaring. Reference number 102 shows a PLA fiber in the same composition with a high melting point at about 175C. Note that these different melting points are not a core fiber and a surrounding sheath fiber as previously known in the art.

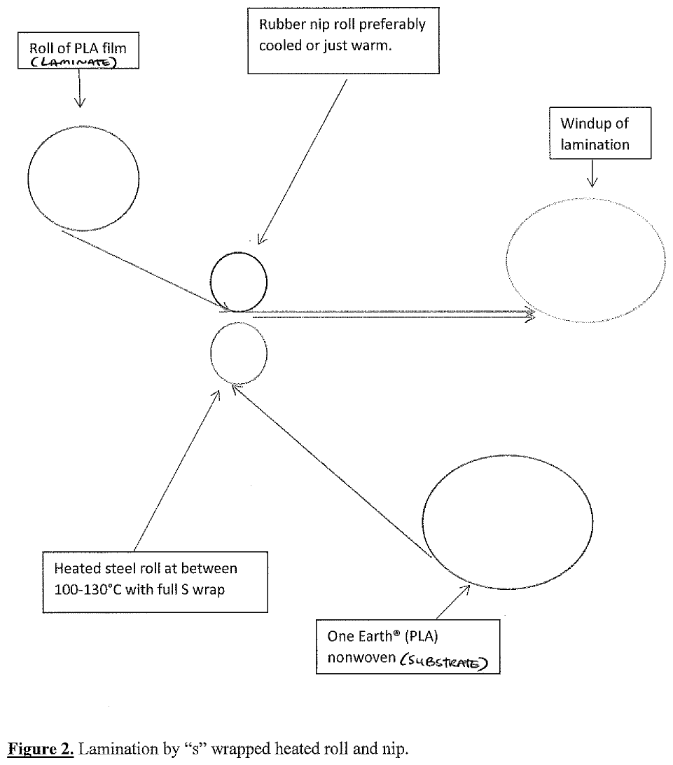

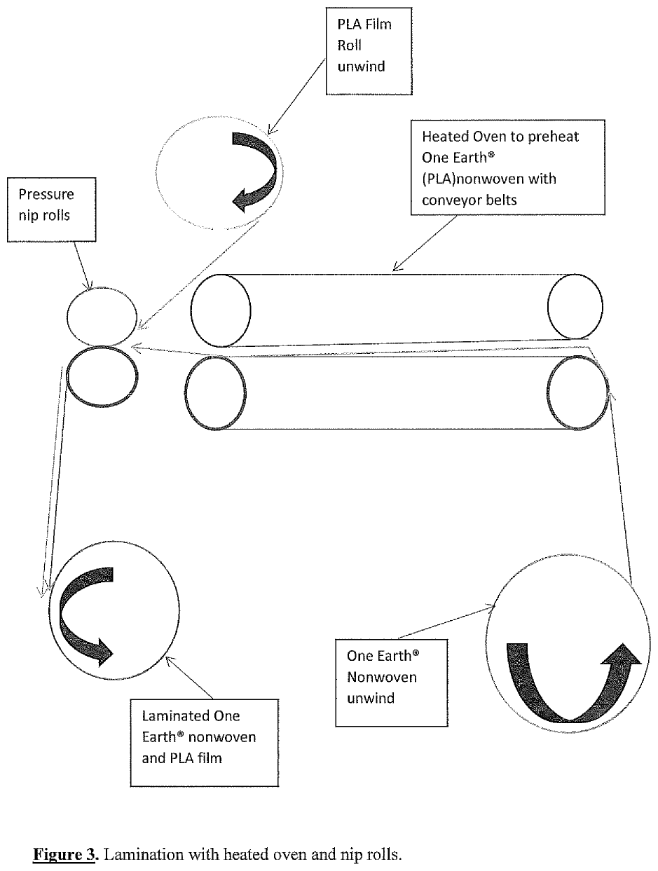

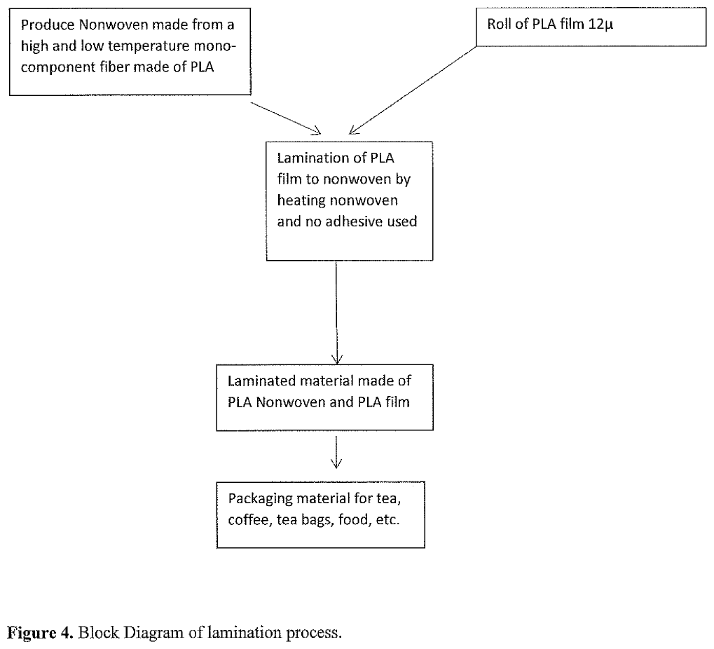

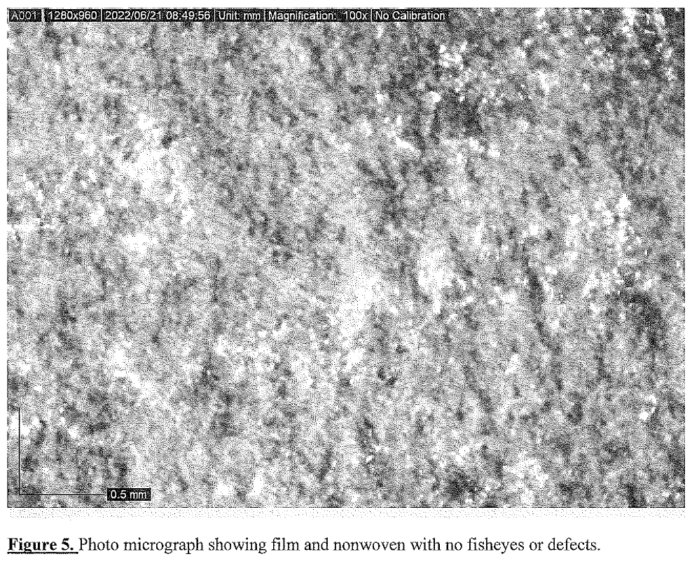

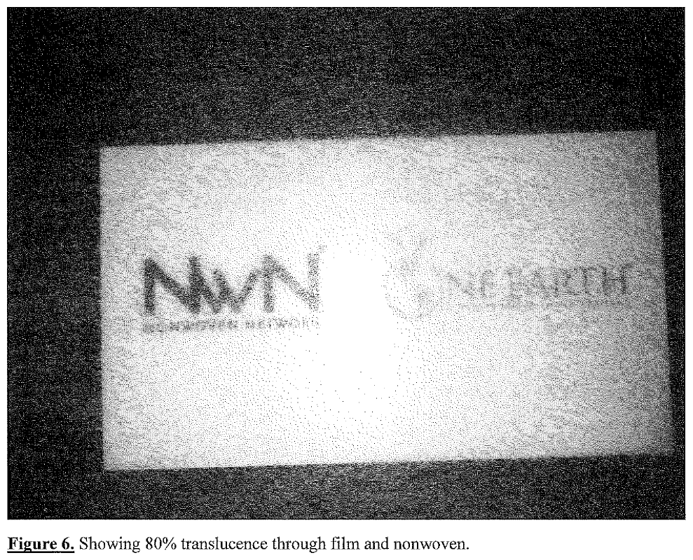

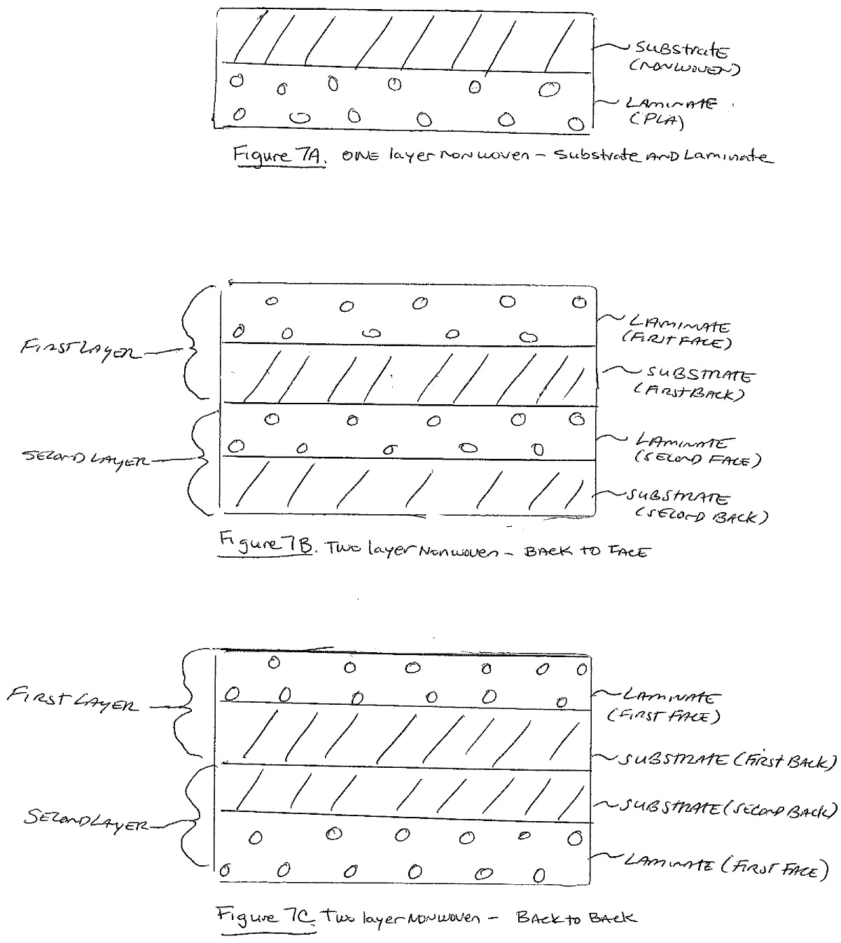

FIG. 2 shows a diagram of lamination using a heated roll and nip to heat only the nonwoven. FIG. 3 illustrates a diagram using a double belt laminator and oven to preheat the nonwoven and then a cold nip to complete the lamination without adhesive. FIG. 4 shows a block diagram illustrating one embodiment of a manufacturing method of the lamination of the nonwoven and film in a block diagram shown in FIG. 1. FIG. 5 is a photomicrograph of the laminated nonwoven and film showing no air bubble or fisheyes. FIG. 6 illustrates one example showing 80% semi-transparency through film and nonwoven. As shown in this figure a card having indicia is placed in the semitransparent pouch. Even though the nonwoven has a laminate visibility of the pouch, in this case a business card, is achieved.

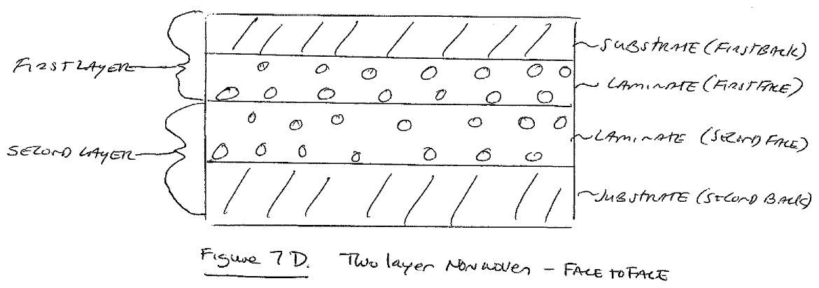

FIGS. 7A-7D illustrate the nonwoven and laminate in different configurations. Shown in FIG. 7A is a single layer cross sectional view that comprises of a substrate nonwoven and a laminate. In this example the laminate is PLA. Again depending on the embodiment the nonwoven and the laminate may be various materials or the same materials as previously described herein.

FIG. 7B is also a cross sectional view, however showing the bonding of two layers. It is within the scope of the invention to have multiple layers beyond two layers depending on the packaging or other product requirements. Such additional layers are added using the principles of the invention described herein. As shown in FIG. 7B, the first layer comprises a first laminate or first face, and a first substrate or first back. The first laminate is bonded to the first substrate as described herein. Again for purposes of this disclosure the first laminate and first substrate may be the same material or different materials. In addition the first laminate and first substrate may include the materials previous listed herein and additional materials that can utilize the principles of this invention. The second layer in FIG. 7B has a second laminate or second face, and a second substrate or second back. The second laminate is bonded to the second substrate similarly manufactured as the first layer. In addition the first layer is bonded to the second layer. Manufacturing techniques described herein may be utilized to also bond the first and the second layers together. This configuration shown in FIG. 7B is known as a back to face configuration where the second laminate or second face is bonded with the first substrate or first back, and the second laminate is also boned to the second substrate or second back. Again the first laminate and the second laminate may be the same material or different materials. In addition the first substrate and the second substrate may be the same materials or different materials.

Adverting to FIG. 7C, shown in a back to back configuration where the first substrate or first back, and the second substrate or second back are bonded together to bond the first and second layers together. Similar material considerations and manufacturing processes apply to FIG. 7C as previously described herein and as described in FIG. 7A and FIG. 7B.

FIG. 7D again like FIG. 7C has similar material considerations and manufacturing processes apply as previously described herein and as described in FIG. 7A and FIG. 7B. FIG. 7D like FIG. 7A-7D is a cross sectional view of the laminate and substrate. Shown in this FIG. 7D is a face to face configuration wherein the first laminate and the second laminate are bonded together to bond the first and second layers together. Again the first laminate is also boned to the first substrate and the second laminate is bonded to the second substrate. As with the other figures shown, additional layers may be added to two layers either by using the same configuration shown in each individual FIGS. 7B-7D, or by varying the configurations by using a few configurations and combining the configurations shown in FIGS. 7B-7D. Various configurations are available using the principles of the invention.

While the US patent U.S. Pat. No. 8,828,895 to Foss provided for media up to 55 grams/square meter (gsm or GSM), some nonwovens, however, are up to 150 gsm in heavier weights to obtain the strength and stiffness required. Thus this patent, although technically suitable for other applications, is not useful for the present composition and method of making a nonwoven fabric with a laminate and without an adhesive.

It was found in the present invention that by regulating the percentage of low melt fibers and processing conditions, the various properties of thickness, porosity, tensile strength and elongation can be controlled.

The following Examples further describe this material and process. The below examples are given merely to show how the invention may be implemented and in no way limits the invention to any particular embodiment.

### EXAMPLE 1

The first work was using nonwovens produced under the Foss '895 patent at 50 gsm and 20% low melt mono-component fiber and 80% of the high melt fiber. The nonwoven had an air permeability of 70 cu ft/min. This nonwoven was processed on the laminator in figure two at temperatures from 100 to 140° C. The film was placed on the hot fabric and passed through the nip roll. The bond was poor and delaminated easily. Thus there was no improvement with the lamination of the film.

### EXAMPLE 2

A new nonwoven was produced using a blend of 35% low melt fiber and 65% high melt fiber at a weight of 70 gsm was tried. This produced a stiffer nonwoven and the air permeability was reduced to 80 cu feet/min. The same laminator was used with temperatures from 100 to 140C The film was placed on the hot fabric and passed through the nip roll. The best results were obtained at 130C but the bond between the film and nonwoven were still marginal.

A further set of trials were performed to determine the effect of blend percentage and calender temperature and pressure to reduce permeability. This shown in Chart 1. The blend was 40% low melt and 60% high melt with calender temperature of 150-151° C. and pressure of 160 bar. The thickness was at 131-136μ and permeability 19.1-20.3 CFM. The next trial increased the calender temperature to 154-155° C. with pressure still at 150 bar. The thickness dropped to 122-128μ and air permeability reduced to 14.7-16.3 CFM. Finally the blend was changed to 45% low melt and 55% high melt with a calender temperature of 154-155° C. and pressure increased to 160 bar. The thickness reduced to 103-108μ and air permeability reduced to 4.3-5.7 CFM. It was shown that increasing the low melt percentage and increasing temperature and calender pressure reduced the thickness and air permeability.

### EXAMPLE 3

Another trial was made using a blend of 45% low melt and 55% high melt at gsm with improved calender conditions as in paragraph 0046. The laminator was tested at temperatures from 120-140° C. The film was placed on the hot fabric and passed through the nip roll. The best results were between 125-130C or 140-145C and an excellent bond occurred The air permeability of the nonwoven was <4-5 Cu Ft/min by itself but the laminated product with the 12μ PLA film had ZERO air flow using a Frazer air permeameter

A fourth trial was made using two fabrics with the 45% low melt blend and 55% high melt at 35 gsm. The two fabrics were first laminated together in the same laminator and nip roll. This produced a nonwoven of 70 gsm also with <1 cu ft/min air flow. The fabrics were then laminated to the 12μ Film through laminator and nip roll at 125° C. Excellent bond strength and air permeability of ZERO cu ft/min. The benefit is that there is a probability that by laminating two fabric by laminating face to face or back to back any light and heavy areas may cancel each other out resulting in an even more impermeable nonwoven before laminating the PLA film. There is an advantage to laminating two fabrics together laminating either face to face or back to back because it randomizes any thin or light weights occurring in the same spot and improves uniformity.

Further, as the benefits of laminating two fabrics together, a further benefit would result by having two cards with separate blending systems so that two layers could be produced simultaneously with different blend percentages. This would permit the layer closest to the lamination to have a higher % of low melt fibers to increase the lamination bond and increase impermeability of the laminated product by having more flow of the low melt “adhesive” into to laminated substrate. The outer layer could have a lower percentage of low melt fibers to give it a more appealing textile or non-plastic feel and provide improved properties for printing.

A fifth trial was run using 15μ and 25μ PLA films. The purpose was to increase seam strength when sealing the edges of the gusseted pouch. The result also has zero air flow.

In the third trial, it was observed that the product provided about 85% transparency which will allow the consumer to see the products within the bag or pouch. In additional trials it was determined that increasing combinations of heat and pressure improved the translucence.

In another trial, A nonwoven was made using 45% PLA low melt binder with a 1.5d×51 mm PET fiber containing 0.8% Titanium dioxide. This produced an opaque nonwoven. This could be made with a high melt PLA fiber containing Titanium Dioxide to make an opaque packaging material. There is a need for opaque nonwovens to reduce the amount of printing ink for both cost and environmental reasons.

Printing of the nonwoven with either digital ink or water based conventional printing has excellent bond to the nonwoven fabric of this invention. The colors are bright and clear. The printing can be done on either an unprinted nonwoven describe here or the laminated composite. Use of the laminated composite puts the printing in on the outside of the package and not in contact with the food.

Trials were run on a high speed pouch machine and samples were produced of a gusseted pouch, a three side seal envelope and “form, fill, and seal” envelope or sachet. In another variant, a compostable “zipper” was successfully inserted in the pouch to allow for multiple opening and closing. The net effect was that all components are fully compostable and biodegradable.

Finally, an impermeable film of PLA can be laminated to prevent airflow in either direction of a packing material.

The following aspects were found possible utilizing the teachings of the invention. A non-woven fabric composition web for a tea or a coffee wrapper and tag consists of a tea or a coffee wrapper and tag having a plurality of mono-component, mono-constituent polylactic acid (PLA) fibers and a pigment. The polylactic acid(PLA) fibers as described herein have different deniers and a blend percentages of a high melt PLA fiber and a low melt PLA fibers with a melt flow temperature in a range of 145-175° C. and 105-165° C., respectively. In one aspect, the fibers have a weight range from 45 gsm to 150 gsm. In another aspect, the fibers have a weight range from over 75 gsm to 150 gsm. The fibers have a percentage of a high melt fiber ranging from 10% to 60% and a percentage of a low-melt fiber ranging from 40% to 90%.

Depending on the embodiment, the fibers may also have a denier ranging from 0.7 to 6.0 denier. The fibers may also have a length that ranges from 12 mm to 130 mm. Fiber denier ranges from 1.5 to 2.5 denier as also achievable using the principles of the present invention. The fibers may also have a length that ranges from 25 mm to 51 mm.

Depending on the embodiment, the pigment used with the fibers is a titanium dioxide pigment for making the non-woven fabric composition opaque in color. The pigment may also be a color fast pigment selected from a group consisting of Phthalo Blue, Phthalo Green, iron oxide, Yellow Ochre, and any combination thereof.

In addition depending on the embodiment, the pigment is added to either the low melt PLA fiber, the high melt PLA fiber, or both the low and the high melt PLA fibers to provide a colored fabric. The composition with packaging film may also be used for wrapping meat, vegetables, fish, candy, cheese, pet food, or any foodstuff to provide controlled breathability and rapid biodegradability.

Any headings and sub-headings utilized in this description are not meant to limit the embodiments described thereunder. Features of various embodiments described herein may be utilized with other embodiments even if not described under a specific heading for that embodiment.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A non-woven fabric composition web for packaging food stuff, comprising:
a plurality of biodegradable, mono-component, mono-constituent up to 95% amorphous low melt polylactic acid (PLA) fibers having a melt flow temperature in a range of 105-165° C.;
a plurality of biodegradable, mono-component, mono-constituent semi-crystalline and/or crystalline high melt polylactic acid (PLA) fibers having a melt flow temperature in a range of 145-175° C.;
the low and the high melt polylactic acid(PLA) fibers both having different deniers and a blend percentages from 35%/65% to 90%/10% low melt to high melt fibers forming a PLA nonwoven fabric;
a substrate selected from a group consisting of another nonwoven, a layer of paper, a layer of polymer film, a PLA film, a mixed polymer and metallic layer or a ceramic layer, an aluminum foil layer, a metallic layer, and any combination thereof;
wherein, the amorphous mono-component PLA fiber forms an adhesive on a surface of the PLA when subjected to heat in a range of about 110-150° C. and the substrate is laminated unto the PLA film or other substrate without the use of an external adhesive to form an impermeable membrane void of air bubbles or fisheyes in the impermeable membrane.

2. The non-woven fabric composition in claim 1, wherein the PLA fiber includes a pigment selected from a group consisting of Titanium Dioxide, Phthalo Blue, Phthalo Green, iron oxide, Yellow Ochre, and any combination thereof.

3. The non-woven fabric composition in claim 1, wherein the fibers have a weight range from 40 to 150 gsm, or from 70 gsm to 150 gsm.

4. The non-woven fabric composition in claim 1, wherein the fibers have a percentage of a high melt fiber ranging from 10% to 65%, and a percentage of a low-melt fiber ranging from 35% to 90%.

5. The non-woven fabric composition in claim 1, wherein the fibers have a denier ranging from 0.7 to 6.0 denier, and a length that ranges from 12 mm to 130 mm.

6. The non-woven fabric composition in claim 1, wherein a translucence or transparent property of the nonwoven increases as the percentage of low melt amorphous PLA fiber increases or wherein calendar temperatures and pressure are increased.

7. The non-woven fabric composition in claim 1, wherein the impermeability increases as the percentage of low melt amorphous PLA increases; and wherein at least two light weight fabrics having a weight between 30 to 150 GSM (Gram/m²) are laminated together in one lamination process either face to face or back to back for increased impermeability and increased uniformity as compared to no lamination process.

8. The non-woven fabric composition in claim 1, wherein the fibers have a denier ranging from 1.2 to 2.5 denier, and the fibers have a length that ranges from 25 mm to 51 mm.

9. The nonwoven fabric composition in claim 1 biodegrades completely in 90 days or less in a compost.

10. The non-woven fabric composition in claim 1, wherein the PLA fiber further includes a pigment that is a titanium dioxide pigment for making the non-woven composition opaque in color; and
wherein the pigment is combined with either the low melt PLA fiber, the high melt PLA fiber, or both the low and the high melt PLA fibers to provide a colored fabric.

11. The non-woven fabric composition in claim 1, wherein the substrate and the film form a first layer having a first face and a first back; and a second substrate bonded to a second laminate forms a second layer having a second face and a second back; and
wherein the first layer is bonded to the second layer in a face to face configuration, a face to back configuration, or a back to back configuration for randomizing any thin or light weight spots occurring in a same spot on the first layer or the second layer; and for improving uniformity in a combined first and second layers as compared individually to the first or second layers.

12. The non-woven fabric composition in claim 11, wherein the first layer and the second layer comprises different blend percentages.

13. The non-woven fabric composition in claim 11, wherein either the first layer or the second layer comprises a 45% low melt blend and a 55% high melt at 35 gsm with

14. The non-woven fabric composition in claim 13, the first and the second layer combined forming a nonwoven of 70 gsm with <1 cu ft/min air flow.

15. The non-woven fabric composition in claim 11, wherein the first and the second layers are laminated together in a same laminator and a same nip roll.

16. A process of making a non-woven fabric composition web for packaging food stuff or other products, comprising:
preparing a polylactic acid (PLA) nonwoven fabric with the nonwoven fibers: wherein the fabric includes:
a plurality of biodegradable, mono-component, mono-constituent up to 90% amorphous low melt polylactic acid (PLA) fibers having a melt flow temperature in a range of 105-165° C.;
a plurality of biodegradable, mono-component, mono-constituent semi-crystalline and/or crystalline high melt polylactic acid (PLA) fibers having a melt flow temperature in a range of 145-175° C.
the low and the high melt polylactic acid(PLA) fibers both having different deniers and a blend percentages forming a PLA nonwoven fabric;
forming an adhesive with the amorphous mono-component PLA on a surface of the PLA when subjected to heat in a range of about 110-145° C.; and
bonding or laminating a substrate to the PLA film without the use of an external adhesive to form an impermeable membrane void of air bubbles or fisheyes in the impermeable membrane due a combination of surface adhesive from the low melt PLA and the film that results in an impermeable product or a non-woven fabric composition web for packaging food stuff or other products;
wherein the substrate is selected from a group consisting of another nonwoven, a layer of paper, a layer of polymer film, a PLA film, a mixed polymer and metallic layer or a ceramic layer, an aluminum foil layer, a metallic layer, and any combination thereof.

17. The process in claim 16, further including printing with text, drawings, or logos in biodegradable colored ink on the impermeable membrane or the nonwoven fabric.

18. The process in claim 16, further includes using the impermeable product or the non-woven fabric composition web for a tea or a coffee wrapper and tag; or for a wrapping for meat, vegetables, fish, candy, cheese, pet foods or foodstuff to provide controlled breathability and rapid biodegradability.

19. The process in claim 16, further includes inserting a biodegradable zipper into a pouch, a bag, or a sachet; wherein the pouch, the bag, or the sachet is formed by the impermeable product or a non-woven fabric composition web.

20. The process in claim 16, further includes adjusting heat during lamination so that self-adhesive PLA flows into an area of interstices of both the PLA nonwoven fabric and the substrate to increase a degree of impermeability; and wherein at higher temperatures viscosity of the low melt PLA decreases to allow flow, particularly in any of the area of interstices that are not filled.
